(19) United States
(12) Patent Application Publication
(10) Pub. No.: US 2025/0253488 A1
(43) Pub. Date: Aug. 7, 2025

(54) SOLID STATE BATTERY, METHOD OF MANUFACTURING THE SAME, AND BATTERY MODULE

(71) Applicant: TOYOTA JIDOSHA KABUSHIKI KAISHA, Toyota-shi (JP)

(72) Inventor: Kenichi KAKISHITA, Nagoya-shi (JP)

(73) Assignee: TOYOTA JIDOSHA KABUSHIKI KAISHA, Toyota-shi (JP)

(21) Appl. No.: 18/925,514

(22) Filed: Oct. 24, 2024

(30) Foreign Application Priority Data
Feb. 2, 2024 (JP) 2024-015068

(51) Int. Cl. H01M 50/477; H01M 10/0585; H01M 50/474

(52) U.S. Cl. CPC H01M 50/477; H01M 10/0585; H01M 50/474

(57) ABSTRACT

The solid state battery of the present disclosure includes an electrode stack. The electrode stack includes a first current collector layer, a first electrode active material layer, a solid electrolyte layer, a second electrode active material layer, and a second current collector layer in this order. The electrode stack has a main body region and a tapered region formed at an end. An insulating member is disposed from at least a part of the inclined surface of one of the tapered regions through the end surface of the electrode stack and over at least a part of the other inclined surface. The length of the insulating member in the stacking direction of the electrode stack is smaller than the thickness of the main body region.

### CROSS-REFERENCE TO RELATED APPLICATION

This application claims priority to Japanese Patent Application No. 2024-015068 filed on Feb. 2, 2024, incorporated herein by reference in its entirety.

### BACKGROUND

### 1. Technical Field

The present disclosure relates to a solid state battery, a method of manufacturing the same, and a battery module.

### 2. Description of Related Art

In the automotive industry, battery electric vehicles, hybrid electric vehicles, and the like have been developed due to an increase in awareness of environmental issues, and there is a high demand for high-voltage secondary batteries. In the field of portable electronic devices, on the other hand, there is a demand for high-capacity secondary batteries that are small in size, light in weight, and capable of continuous operation for a long time along with the popularization and development of such devices.

As a high-voltage and high-capacity battery, for example, there is known a battery including an electrode stack in which a negative electrode current collector layer, a negative electrode active material layer, a solid electrolyte layer, a positive electrode active material layer, and a positive electrode current collector layer are arranged in this order.

In such a battery, for example, when the current collector layer of one electrode extends from the electrode stack, the current collector layer may contact the current collector layer and/or the active material layer of the other electrode to cause a short circuit. A portion of the current collector layer that extends from the electrode stack is referred to as a current collector tab. This short circuit is particularly likely to occur when the area of the current collector layer of one electrode is larger than the area of the current collector layer of the other electrode. Therefore, a technique of suppressing such a short circuit has been developed.

Japanese Unexamined Patent Application Publication No. 2018-049696 (JP 2018-049696 A), for example, discloses a method of manufacturing a stacked all-solid-state battery. In this manufacturing method, a first stack in which a solid electrolyte layer, a first active material layer (electrode active material layer), a first current collector layer, a first active material layer, and a solid electrolyte layer are stacked in this order is prepared. The first current collector layer has a first current collector tab that extends laterally from the stacked all-solid-state battery. An insulating portion (insulating member) is formed by applying an insulating coating liquid to an end portion of the first stack. The first stack having the insulating portion formed thereon, a second active material layer, and a second current collector layer are stacked. In this manner, a battery structure (electrode stack) including a plurality of second stacks in which a second current collector layer having a second current collector tab, a second active material layer, a solid electrolyte layer, a first active material layer, a first current collector layer having a first current collector tab, a first active material layer, a solid electrolyte layer, and a second active material layer are stacked in this order is prepared. The second current collector layer has a second current collector tab that extends laterally from the stacked all-solid-state battery. A plurality of second current collector tabs that extends from a plurality of second current collectors in the battery structure is joined to each other.

### SUMMARY

For example, an insulating member is applied to an end surface of a preliminary stack composed of layers of the electrode stack other than the second current collector layer. The insulating member is applied to the end surface of the preliminary stack when manufacturing an electrode stack by stacking the second current collector layer on the preliminary stack. Then, the insulating member may be applied to a part of the main surface of the preliminary stack that is adjacent to the end surface. The inventors of the present disclosure have found that in such a case, the thickness of a portion of the battery in which the insulating member is formed on the main surface of the preliminary stack may be larger than the thickness of the other portions. The inventors of the present disclosure have found that as a result, the volume efficiency of the battery in the stacking direction of the electrode stack may decrease.

Further, the inventors of the present disclosure have found that in such a case, the second current collector layer and the insulating member may interfere with each other, and that as a result, the insulating member may be peeled off from the electrode stack, reducing the reliability of insulation by the insulating member.

An object of the present disclosure is to provide a solid state battery having high volume efficiency in the stacking direction of an electrode stack and high reliability of insulation by an insulating member, a method of manufacturing the same, and a battery module including such a solid state battery.

The inventors of the present disclosure have found that the above issue can be addressed by the following means.

### First Aspect

A solid state battery comprising an electrode stack, in which:
the electrode stack includes a first current collector layer, a first electrode active material layer, a solid electrolyte layer, a second electrode active material layer, and a second current collector layer arranged in this order;
the electrode stack includes a main body region and a tapered region formed at an end portion;
an insulating member is disposed to extend from at least a part of an inclined surface on one side of the tapered region to at least a part of an inclined surface on another side via an end surface of the electrode stack; and
a length of the insulating member in a stacking direction of the electrode stack is less than a thickness of the main body region.

### Second Aspect

The solid state battery according to the first aspect, in which the tapered region of the electrode stack is a region formed by cutting at least a part of a region formed due to the second electrode active material layer being smaller in a surface direction than the first electrode active material layer in the stacking direction of the electrode stack.

### Third Aspect

A battery module including
the solid state battery according to the first or second aspect.

### Fourth Aspect

A method of manufacturing the solid state battery according to the first aspect, including:
(a) stacking the first current collector layer, the first electrode active material layer, the solid electrolyte layer, and the second electrode active material layer in this order to form a preliminary stack having the tapered region at an end portion;
(b) applying the insulating member so as to extend from at least a part of an inclined surface on one side of the tapered region to at least a part of an inclined surface on another side via an end surface of the preliminary stack such that a length of the insulating member in a stacking direction of the electrode stack is less than a thickness of the main body region; and
(c) after applying the insulating member, stacking the second current collector layer on the preliminary stack to form the electrode stack.

### Fifth Aspect

The method according to the fourth aspect, further including forming the tapered region by cutting at least a part of a region formed due to the second electrode active material layer being smaller in a surface direction than the first electrode active material layer in the stacking direction of the electrode stack in the (a).

According to the present disclosure, it is possible to provide a solid state battery having high volume efficiency in the stacking direction of an electrode stack and high reliability of insulation by an insulating member, a method of manufacturing the same, and a battery module including such a solid state battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view showing an example of a solid state battery of the present disclosure;

FIG. 2 is a schematic cross-sectional view illustrating an example of an arrangement mode of an insulating member in the solid state battery of the present disclosure;

FIG. 3A is a schematic diagram illustrating an example of a method of manufacturing a solid state battery of the present disclosure;

FIG. 3B is a schematic diagram illustrating an example of manufacturing a solid state battery of the present disclosure;

FIG. 3C is a schematic diagram illustrating an example of manufacturing a solid state battery of the present disclosure;

FIG. 3D is a schematic diagram illustrating an example of manufacturing a solid state battery of the present disclosure; and

FIG. 4 is a schematic perspective view illustrating an example of a battery module of the present disclosure.

### DETAILED DESCRIPTION OF EMBODIMENTS

Hereinafter, embodiments of the present disclosure will be described in detail with reference to the drawings. It should be noted that the present disclosure is not limited to the following embodiments, and various modifications can be made within the scope of the gist of the disclosure. In addition, the dimensional relationship in the drawings does not reflect the actual dimensional relationship.

### Solid State Battery

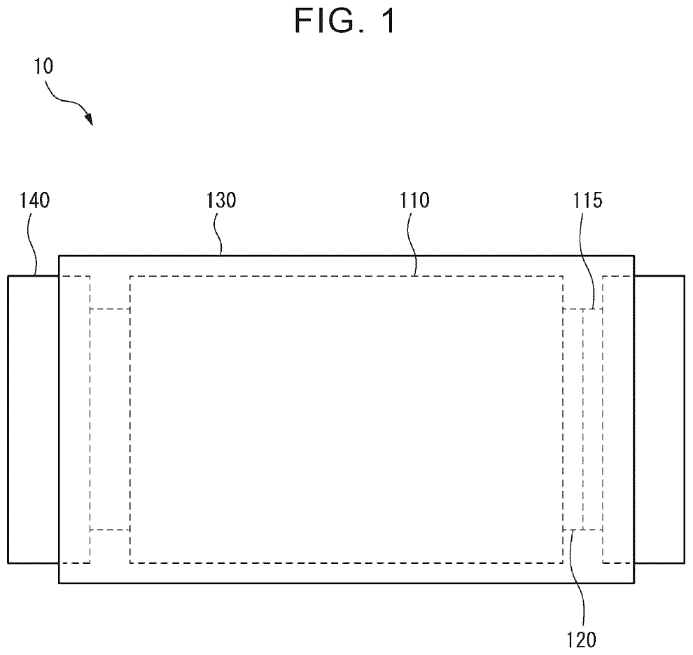

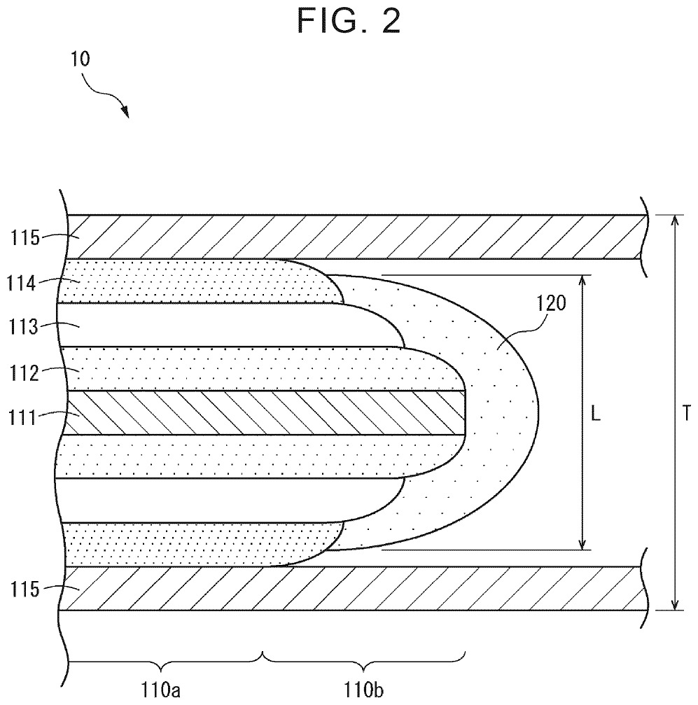

As illustrated in FIG. 1, a solid state battery 10 of the present disclosure includes an electrode stack 110. As illustrated in FIG. 2, the electrode stack 110 includes a first current collector layer 111, a first electrode active material layer 112, a solid electrolyte layer 113, a second electrode active material layer 114, and a second current collector layer 115 in this order. The electrode stack has a main body region 110a and a tapered region 110b formed at the end. The insulating member 120 is disposed from at least a part of the inclined surface of one of the tapered regions to at least a part of the other inclined surface via the end surface of the electrode stack. The length L of the insulating member in the stacking direction of the electrode stack is smaller than the thickness T of the main body region. FIG. 2 is an enlarged schematic cross-sectional view of a portion of the insulating member 120 of the solid state battery 10 of the present disclosure.

The inventors of the present disclosure have found that, by making the length of the insulating member in the stacking direction of the electrode stack smaller than the thickness of the main body region, the volume efficiency of the battery in the stacking direction of the electrode stack increases. The inventors of the present disclosure have found that the insulating members do not interfere with each other, especially when a plurality of electrode stacks are laminated. Further, the Disclosing Person, etc. has found that the insulating member is hardly dropped off by disposing the insulating member from at least a part of the inclined surface of one of the tapered regions of the electrode stack via the end surface of the electrode stack over at least a part of the other inclined surface. As a result, the Disclosing Party has found that the reliability of insulation by the insulating member is increased.

In the context of the present disclosure, a “solid state battery” means a battery that uses at least a solid electrolyte as an electrolyte, and therefore a solid state battery may use a combination of a solid electrolyte and a liquid electrolyte as an electrolyte. The solid state battery of the present disclosure may be an all-solid state battery, that is, a battery using only a solid electrolyte as an electrolyte.

In the context of the present disclosure, “preliminary stack” means a laminate having a first current collector layer, a first electrode active material layer, a solid electrolyte layer, and a second electrode active material layer in this order. The “electrode stack” means a stack in which a second current collector layer is laminated on a preliminary stack.

As illustrated in FIG. 2, in the solid state battery 10 of the present disclosure, the insulating member 120 is disposed from at least a part of the inclined surface on one side in the tapered region 110b through the end surface of the electrode stack 110 and over at least a part of the inclined surface on the other side. The insulating member 120 may be disposed so as to cover the first current collector layer 111, and in particular, may be disposed so as to cover the first current collector layer 111 and the first electrode active material layer 112. With such a configuration, it is easy to prevent a short circuit between the second current collector layer 115 and the first current collector layer 111 and/or the first electrode active material layer 112. The insulating member 120 may be disposed from a first portion of one inclined surface to a second portion of the other inclined surface via an end surface of the electrode stack 110. The first portion is a portion formed by the second electrode active material layer 114. The second portion is a portion formed by the second electrode active material layer 114. In particular, as illustrated in FIG. 2, the insulating member 120 may be disposed so as to ride on the second electrode active material layer 114.

The tapered region of the electrode stack may be a region formed by cutting at least a part of the region formed due to the second electrode active material layer being smaller in the surface direction than the first electrode active material layer in the stacking direction of the electrode stack. With such a configuration, the volume efficiency of the battery in the surface direction of the electrode stack can be increased.

For example, in a lithium ion secondary battery, in order to suppress the deposition of dendrites on the negative electrode active material layer, the positive electrode active material layer may be made smaller than the negative electrode active material layer. Therefore, in the case where the positive electrode active material layer is made smaller than the negative electrode active material layer, the first current collector layer may be the negative electrode current collector layer, and the first electrode active material layer may be the negative electrode active material layer. The second electrode active material layer may be a positive electrode active material layer, and the second current collector layer may be a positive electrode current collector layer.

Hereinafter, elements constituting the battery of the present disclosure will be described.

### Electrode Stack

The solid state battery 10 of the present disclosure includes an electrode stack 110. The electrode stack functions as a power generation element of the battery.

The electrode stack includes a first current collector layer, a first electrode active material layer, a solid electrolyte layer, a second electrode active material layer, and a second current collector layer in this order. Preferably, the electrode stack includes, on both sides of the first current collector layer, a first electrode active material layer, a solid electrolyte layer, a second electrode active material layer, and a second current collector layer in this order. That is, the electrode stack may include a second current collector layer, a second electrode active material layer, a solid electrolyte layer, a first electrode active material layer, a first current collector layer, a first electrode active material layer, a solid electrolyte layer, a second electrode active material layer, and a second current collector layer in this order.

The electrode stack has a main body region and a tapered region formed at an end. Here, the main body region means a main portion having a substantially uniform thickness and not having a tapered shape.

The shape of the electrode stack in the plane direction is not particularly limited, but may include, for example, a top surface portion, a bottom surface portion opposed to the top surface portion, and four side surface portions connecting the top surface portion and the bottom surface portion. The shape of the top surface portion is not particularly limited, but examples thereof include quadrilaterals such as squares, rectangles, rhombuses, trapezoids, and parallelograms. The shape of the top surface portion may be a polygonal shape other than a quadrilateral, or may be a shape having a curve such as a circular shape. The shape of the bottom portion may be similar to the shape of the top portion. The shape of the side surface portion is not particularly limited, but examples thereof include quadrilaterals such as squares, rectangles, rhombuses, trapezoids, and parallelograms.

The size of the electrode stack is not particularly limited, and can be appropriately designed according to, for example, characteristics of a desired battery.

In the electrode stack, the first current collector layer may be a negative electrode current collector layer, the first electrode active material layer may be a negative electrode active material layer, the second electrode active material layer may be a positive electrode active material layer, and the second current collector layer may be a positive electrode current collector layer. That is, the electrode stack may include a negative electrode current collector layer, a negative electrode active material layer, a solid electrolyte layer, a positive electrode active material layer, and a positive electrode current collector layer in this order. The material of each layer is not particularly limited, and a material commonly used as a material constituting each layer can be employed. The thickness of each layer is not particularly limited

### Insulating Member

The shape of the insulating member 120 is not particularly limited.

The size of the insulating member 120 is not particularly limited, but it can be appropriately designed in consideration of the volume efficiency of the battery.

The insulating member 120 may include a thermoplastic resin or may be a thermoplastic resin. The thermoplastic resin is not particularly limited, and may be a non-reactive type or a reactive type. The non-reactive thermoplastic resin is not particularly limited, and examples thereof include polyester-based resins such as ethylene-vinyl acetate (EVA), synthetic rubber-based resins, olefin-based resins, polyamide-based resins, and polyethylene terephthalate (PET). The reaction type resin is not particularly limited, and a urethane-based resin is exemplified.

The insulating member 120 may include a curable resin or may be a curable resin. The curable resin is not particularly limited, and examples thereof include a thermosetting resin and a photocurable resin. Examples of these resins include acrylic resins and epoxy resins.

By using such a resin as the insulating member 120, it is easy to dispose the insulating member 120 on the end face of the electrode stack 110.

The insulating member 120 may be an insulating tape. The insulating tape may be a double-sided tape.

By using an insulating tape as the insulating member 120, the space occupied by the insulating member 120 is reduced, and therefore, the volume efficiency of the battery in the surface direction of the electrode stack can be further improved.

### Laminate Film

The solid state battery 10 of the present disclosure may include a laminate film 130. The laminate film may contain an electrode stack. Specifically, the laminate film may contain the electrode stack by winding the electrode stack. In addition, the laminate film may be composed of the first and second films, and in this case, the electrode stack may be sandwiched and accommodated by the first and second films from above and below in the stacking direction of the electrode stack.

The laminate film may include a sealant resin layer, a metal layer, and a protective resin layer in this order along the thickness direction. Examples of the sealant resin include olefin-based resins such as polypropylene (PP) and polyethylene (PE). Examples of the material of the metal layer include aluminum, aluminum alloy, and stainless steel. For example, polyethylene terephthalate (PET) or nylon may be used as the protective resin layer.

The thickness of each layer constituting the laminate film and the thickness of the laminate film are not particularly limited. The thickness of the sealant resin layer is, for example, 40 μm or more and 100 μm or less. The thickness of the metal layer is, for example, 30 μm or more and 60 μm or less. The thickness of the protective resin layer is, for example, 20 μm or more and 60 μm or less. The thickness of the laminate film is, for example, 80 μm or more and 250 μm or less.

### Current Collector Terminal

The solid state battery 10 of the present disclosure may further include a current collector terminal 140. The current collector terminal may be electrically connected to the current collector of the electrode stack. The material of the current collector terminal is not particularly limited as long as it has a current collector function, and examples thereof include copper and aluminum. As illustrated in FIG. 1, the current collector terminals may be disposed on a pair of opposite side surfaces of the electrode stack.

The shape, size, and the like of the current collector terminal are not particularly limited.

When the battery of the present disclosure has a current collector terminal, the laminate film may house the electrode stack together with the current collector terminal. Specifically, in the laminate film, the electrode stack and the current collector terminal may be wound to accommodate the electrode stack together with the current collector terminal. In addition, the laminate film may be composed of the first and second films. In this case, the electrode stack and the current collector terminal may be sandwiched between the first and second films from above and below in the stacking direction of the electrode stack, and the electrode stack may be accommodated together with the current collector terminal.

The battery may be a lithium-ion secondary battery. Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving of hybrid electric vehicle (HEV), plug-in hybrid electric vehicle (PHEV), or battery electric vehicle (BEV). Also, the battery in the present disclosure may be used as a power source for mobile bodies other than vehicles (for example, railroads, ships, and aircraft), and may be used as a power source for electric products such as an information processing device.

### Method of Manufacturing Solid State Battery

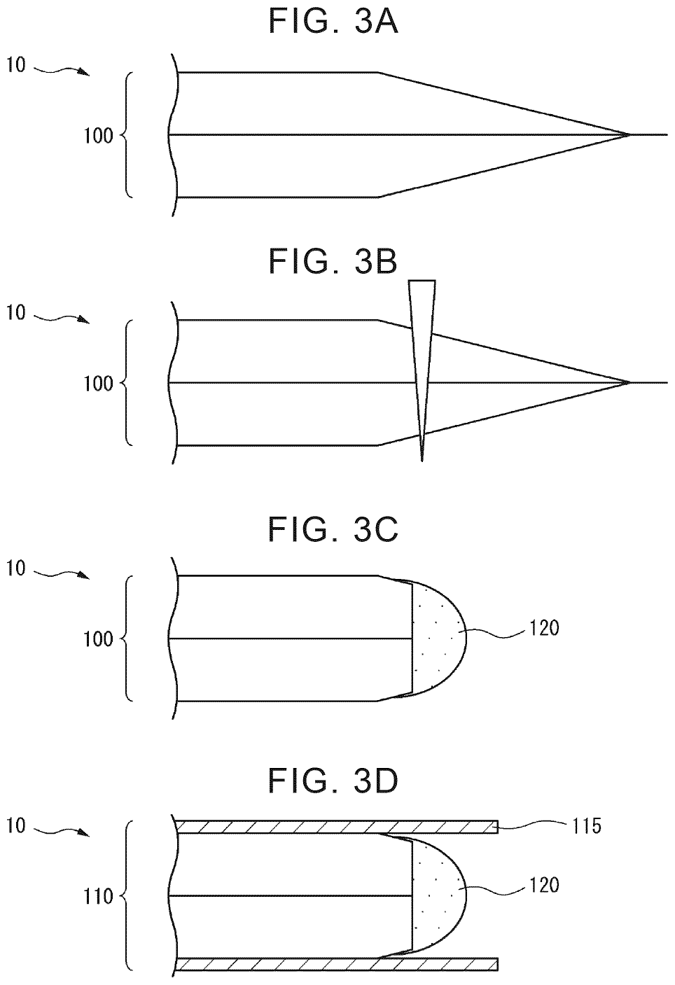

As illustrated in FIGS. 3A to 3D, the disclosed methods of fabricating a solid state battery 10 include the following steps.
(a) The first current collector layer 111, the first electrode active material layer 112, the solid electrolyte layer 113, and the second electrode active material layer 114 are laminated in this order to form a preliminary stack 100 having a tapered region 110b at the end.
(b) The insulating member is applied so that the length L of the electrode stack of the insulating member 120 in the stacking direction is smaller than the thickness T of the main body region 110a from at least a part of the inclined surface of one of the tapered regions through the end surface of the preliminary stack and over at least a part of the other inclined surface.
(c) After the application of the insulating member, the second current collector layer is laminated on the preliminary stack to form an electrode stack.

According to the method of the present disclosure, it is possible to manufacture a solid state battery having high volume efficiency of the battery in the stacking direction of the electrode stack and high reliability of insulation by the insulating member.

As illustrated in FIG. 3A, the disclosed methods include (a) laminating a first current collector layer, a first electrode active material layer, a solid electrolyte layer, and a second electrode active material layer in this order to form a preliminary stack having tapered regions at the ends.

The method of laminating the layers is not particularly limited. For example, a method of laminating a negative electrode active material layer, a solid electrolyte layer, and a positive electrode active material layer by powder compaction is exemplified. Further, there is a method in which a mixture slurry capable of forming the respective layers of the negative electrode active material layer, the solid electrolyte layer, and the positive electrode active material layer is applied to a base material, dried, and laminated.

The method of forming the preliminary stack having the tapered region is not particularly limited. For example, there is a method of laminating the layers such that the first current collector layer, the first electrode active material layer, the solid electrolyte layer, and the second electrode active material layer are smaller in this order in the plane direction.

As illustrated in FIG. 3B, the method of the present disclosure may further include, in step (a), cutting at least a portion of the region formed due to the second electrode active material layer being smaller in the surface direction than the first electrode active material layer in the stacking direction of the electrode stack to form a tapered region. By forming the tapered region by such a method, the volume efficiency of the battery in the plane direction of the electrode stack can be increased.

As illustrated in FIG. 3C, the method of the present disclosure includes (b) applying an insulating member from at least a portion of a slope of one of the tapered regions through an end face of the preliminary stack and over at least a portion of the other slope such that a lamination length of the electrode stack of the insulating member is less than a thickness of the main body region.

The method of applying the insulating member is not particularly limited. For example, in the case where the insulating member is a thermoplastic resin, a method is exemplified in which a molten thermoplastic resin is applied to a desired portion and immersed in the molten thermoplastic resin, and then solidified. For example, in a case where the insulating member is a curable resin, a method is exemplified in which a curable resin is applied to a desired portion, immersed in the curable resin, or the like, and then cured. For example, in a case where the insulating member is an insulating tape, a method of attaching the insulating tape to a desired portion is exemplified.

As illustrated in FIG. 3D, the disclosed methods include (c) laminating a second current collector layer to the preliminary stack after application of the insulating member to form the electrode stack.

The method of forming the electrode stack by laminating the second current collector layer on the preliminary stack is not particularly limited. For example, in a case where the second current collector layer is a metal foil, a method is exemplified in which a metal foil is disposed on the second electrode active material layer of the preliminary stack and pressed.

### Battery Module

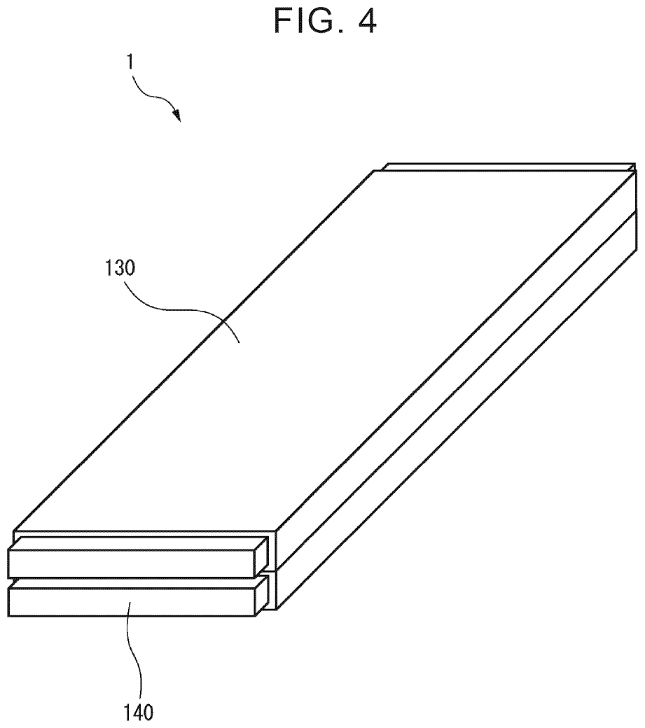

As illustrated in FIG. 4, the battery module 1 of the present disclosure includes the solid state battery 10 of the present disclosure. For the solid state battery of the present disclosure, reference can be made to the above description of the solid state battery of the present disclosure.

As described above, in the solid state battery of the present disclosure, the length of the insulating member in the stacking direction of the electrode stack is smaller than the thickness of the main body region of the electrode stack. Therefore, for example, in the battery module of the present disclosure having a plurality of solid state batteries of the present disclosure, the effect of improving the volume efficiency of the battery in the stacking direction of the electrode stack becomes more remarkable.

The number of the solid state batteries of the present disclosure in the battery module of the present disclosure is not particularly limited, and may be at least one. In the battery module of the present disclosure, all of the batteries may be the solid state batteries of the present disclosure. In FIG. 4, an embodiment in which the number of solid state batteries is two is illustrated, but the number of solid state batteries in the battery module of the present disclosure is not limited to this.

What is claimed is:

1. A solid state battery comprising an electrode stack, wherein:
the electrode stack includes a first current collector layer, a first electrode active material layer, a solid electrolyte layer, a second electrode active material layer, and a second current collector layer arranged in an order of the first current collector layer, the first electrode active material layer, the solid electrolyte layer, the second electrode active material layer, and the second current collector layer;
the electrode stack includes a main body region and a tapered region formed at an end portion;
an insulating member is disposed to extend from at least a part of an inclined surface on one side of the tapered region to at least a part of an inclined surface on another side via an end surface of the electrode stack; and
a length of the insulating member in a stacking direction of the electrode stack is less than a thickness of the main body region.

2. The solid state battery according to claim 1, wherein the tapered region of the electrode stack is a region formed by cutting at least a part of a region formed due to the second electrode active material layer being smaller in a surface direction than the first electrode active material layer in the stacking direction of the electrode stack.

3. A battery module comprising the solid state battery according to claim 1.

4. A method of manufacturing the solid state battery according to claim 1, the method comprising:
(a) stacking the first current collector layer, the first electrode active material layer, the solid electrolyte layer, and the second electrode active material layer in an order of the first current collector layer, the first electrode active material layer, the solid electrolyte layer, and the second electrode active material layer to form a preliminary stack having the tapered region at an end portion;
(b) applying the insulating member so as to extend from at least a part of an inclined surface on one side of the tapered region to at least a part of an inclined surface on another side via an end surface of the preliminary stack such that a length of the insulating member in a stacking direction of the electrode stack is less than a thickness of the main body region; and
(c) after applying the insulating member, stacking the second current collector layer on the preliminary stack to form the electrode stack.

5. The method according to claim 4, further comprising forming the tapered region by cutting at least a part of a region formed due to the second electrode active material layer being smaller in a surface direction than the first electrode active material layer in the stacking direction of the electrode stack in the (a).
